(19) United States
(12) Patent Application Publication
(10) Pub. No.: US 2007/0084648 A1
(43) Pub. Date: Apr. 19, 2007

(54) Wheelchair having unitized chassis

(75) Inventors: Steven D. DuFresne, Hartland, WI (US); Christopher Dario Keidl, Hartland, WI (US)

Correspondence Address: REINHART BOERNER VAN DEUREN P.C., 2215 PERRYGREEN WAY, ROCKFORD, IL, 61107, US

(73) Assignee: MobiLife, Delafield, WI (US)

(21) Appl. No.: 11/251,123

(22) Filed: Oct. 14, 2005

(51) Int. Cl. B60K 1/00

(52) U.S. Cl. 180/65.1; 180/907

(57) ABSTRACT

Enhanced stability of a wheelchair having a lift mechanism is provided, through utilization of a support apparatus including a unitized chassis for operatively connecting a seat and wheels of the wheelchair. A tilt sensor and controller preclude operation of the wheelchair with the seat in raised position while the wheelchair is resting on or traversing an uneven or sloping surface.

### FIELD OF THE INVENTION

This invention relates to powered and non-powered wheeled chairs for use by handicapped and disabled persons.

### BACKGROUND OF THE INVENTION

Wheelchairs, both powered and unpowered, have long been used to provide handicapped and disabled persons with independent mobility to assist them in leading more normal lives.

Prior powered wheelchairs, sometimes also referred to as power chairs, have utilized a frame-like chassis fabricated from a number of individual frame elements which are welded and/or bolted together to form the frame-like chassis. A non-structural decorative cover is sometimes provided, for attachment to the chassis, for esthetic or safety considerations. Examples of such frame-like chassis in powered wheelchairs are disclosed in U.S. Pat. No. 6,935,448, to Goertzen et al.; U.S. Pat. No. 6,773,032, to Redman et al.; U.S. Pat. No. 6,640,916, to Schaffner et al.; and U.S. Pat. No. 6,357,776, to Goertzen et al.

The frame-like construction of the chassis in prior powered wheelchairs is undesirable for several reasons. Because such frame-like chassis require complex joining operations for a substantial number of components, the cost for constructing such frame-like chassis is relatively high. Frame-like chassis are also typically structurally inefficient, thereby causing the weight and size of the powered wheelchair to be larger than is desirable. Having a powered wheelchair weigh more, or be larger than it otherwise could be, makes a powered wheelchair having a frame-like chassis more difficult to transport, less capable of being operated in confined areas, and reduces operating time between battery charges, due to the increased power consumption by drive units in moving the extra unnecessary weight of the wheelchair. The frame-like chassis of prior powered wheelchairs also typically flex to a larger degree than is desirable, Such flexing can result in instability, or at least a perception of instability for a person operating the wheelchair.

Some prior wheelchairs, both powered and unpowered, have also incorporated a lifting device, for raising the seat of the wheelchair in a manner allowing better access to countertops, wall mounted cabinets, and to facilitate use of bathroom fixtures or appliances in buildings not constructed specifically for handicapped or disabled persons. The addition of such a lifting device can also facilitate other activities, such as entry into, or exit from, a vehicle, and can allow a person seated in the wheelchair to raise themselves to a position where they can maintain normal eye-level contact with persons who are standing, during social activities. Examples of wheelchairs incorporating such lifting devices are provided by U.S. Pat. No. 6,793,232, to Wing; U.S. Pat. No. 6,431,650, to Visone; U.S. Pat. No. 5,601,302, to Beard et al.; U.S. Pat. No. 4,993,736, to Garman et al.; and U.S. Pat. No. 4,613,151, to Kielczewiski.

Prior wheelchairs having lift mechanisms, regardless of the particular type of lifting apparatus utilized, have proven to be less than satisfactory and/or impractical for a variety of reasons. Some have simply been too large and cumbersome to operate for practical usage. In general, none of the prior approaches to providing a lifting apparatus in a wheelchair has provided sufficient stability, when the lifting device is fully extended to raise the seat to a maximum height above the surface upon which the wheelchair is resting, or over which the wheelchair is traveling, while the wheelchair was traversing an uneven surface, or moving up or down an access ramp.

The inherent instability of prior wheelchairs having a lifting device has sometimes been the result of unavoidable flexing in the frame-like chassis to which the lifting device was attached. Additional flexing in the lifting device itself, and relative movement between components of the lifting device in prior wheelchairs, has also contributed to the instability observed or perceived at the seat of prior wheelchairs. A small movement of only one hundredth of an inch, or so, for example, due to flexing of a frame-like chassis, may be greatly magnified to become 1½ to 2 inches of movement at the seat of the wheelchair, when the lifting device is fully extended. Additional flexing or movement within the lifting device is also substantially magnified as the seat of the wheelchair is lifted further away from the chassis by the lifting device.

Prior wheelchairs having lifting devices have also not heretofore incorporated any sort of sensing and control apparatus for precluding raising of the seat, or for providing automated and safe lowering of the seat, where an attempt is being made to operate the wheelchair with the seat in a raised position while the wheelchair is tilted at an angle which could result in the wheelchair tipping over.

It is desirable, therefore, to provide an improved wheelchair, and/or apparatuses for use in a wheelchair, which overcome one or more of the problems and observed in prior wheelchairs discussed above.

### BRIEF SUMMARY OF THE INVENTION

The invention provides an improved wheelchair through use of a unitized chassis for operatively connecting a seat and wheels of the wheelchair. The unitized chassis utilizes integrally joined plates for bearing structural loads more efficiently and effectively than prior frame-like wheelchair chassis, to provide a wheelchair chassis that is substantially stiffer and lighter weight than prior wheel chair chassis. The unitized chassis also functions as a protective and decorative cover, thereby eliminating the need for a separate non-structural cover of the type typically used in prior wheelchairs having frame-like chassis.

As used herein, with respect to various embodiments of the invention, the term unitized structure refers to a structure having individual components which are integrally joined to one another by a process such as welding or brazing, or to structures having individual elements which are formed, molded, cast, or cured, in such a manner that the individual elements are permanently and integrally connected to one another, rather than being separably joined by bolted connections or other types of removable fasteners. A unitized chassis, according to the invention, may be constructed from a variety of metallic materials, such as aluminum, from non-metallic materials, such as plastics or composite materials, or from a combination of metallic and non-metallic materials.

In one form of the invention, a unitized chassis is provided for operatively connecting a seat and wheels of a wheelchair, wherein the chassis includes a substantially planar base plate, and a peripheral side plate. The planar base plate defines a periphery of the base plate, a longitudinal axis of the chassis, and a transverse axis of the chassis extending substantially perpendicular to the longitudinal axis. The peripheral side plate has an edge thereof joined as a unitized structure to the periphery of the base plate, and has a width thereof extending substantially orthogonally to the base plate. The base plate and peripheral side plate of the chassis may be formed from a single piece of material. The chassis may be constructed such that, when the chassis is oriented for operative attachment of the seat and wheels of the wheelchair, the base plate and peripheral side plate of the unitized chassis form an open-bottomed box-shape shell, with the base plate forming a top surface of the chassis, and the peripheral side plate depending substantially downward from the base plate.

A unitized chassis, according to the invention, may further include at least one longitudinal rib, integrally joined to the base plate, and disposed inboard of the peripheral side plate. The longitudinal rib may be integrally joined at one or both longitudinal ends thereof to the peripheral side plate. The unitized chassis may further include at least one secondary plate, which is offset from the base plate, and joined as a unitized structure to both the peripheral side plate and the longitudinal rib. The secondary plate may be further joined as a unitized structure to the base plate. The unitized chassis may also include one or more transverse ribs integrally joined to the base plate. Transverse ribs may also be integrally joined to other parts of the chassis, such as longitudinal ribs or the peripheral side wall.

The invention may also take the form of a wheelchair apparatus including a seat, wheels, and a unitized chassis, according to the invention, operatively connecting the seat and the wheels. The wheelchair apparatus may further include a motor for driving a driven wheel of the wheelchair by an operative connection between the motor and the driven wheel. A wheelchair, according to the invention, may also include a lift mechanism operatively connecting the seat to the chassis. The lift mechanism may be a scissors lift mechanism.

A wheelchair, according to the invention, may further include a controller having a tilt sensor for sensing an angle of tilt of the wheelchair, and precluding extension of the lift mechanism if the sensed angle of tilt exceeds a predetermined safe angle of tilt. The controller, in a wheelchair according to the invention, may further retract the lift mechanism to a fully lowered position, at a controlled rate of retraction, if the lift mechanism is extended when the tilt sensor detects that the angle of tilt of the wheelchair exceeds the predetermined safe angle of tilt. The predetermined safe angle of tilt may be a function of the extension of the lift mechanism from the fully lowered position and/or the direction of the angle of tilt.

In some forms of the invention, the lift mechanism may be a scissors lift mechanism, having an upper and a lower inner frame, and upper and lower pairs of outer links. The upper and lower inner frames may each have left and right side links thereof joined into a unitized structure by a non-protruding cross member, with each of the left and right side links of the upper and lower inner frames having a respective upper and lower attachment point at opposite ends thereof and a respective intermediate attachment point disposed between the upper and lower attachment points. Each of the outer links in the upper and lower pairs of outer links have upper and lower attachment points at opposite ends thereof and intermediate attachment point disposed between the upper and lower attachment points of the outer links.

The pair of lower outer links includes a right and left outer link, rotatably joined at respective intermediate attachment points thereof to the right and left side links of the lower inner frame respectively, at the intermediate attachment points of the right and left side links of the lower inner frame. The pair of upper outer links includes a right and a left upper outer link rotatably joined at the respective intermediate attachment points thereof to the right and left links of the upper inner frame respectively, at the intermediate attachment points of the right and left side links of the upper inner frame. The lower ends of the right and left upper outer links are rotatably joined respectively to the attachment points at the upper ends of the right and left side links of the lower inner frame. The upper ends of the right and left lower outer links are rotatably joined respectively to the attachment points at the lower ends of the right and left side links of the upper inner frame.

A scissors mechanism, according to the invention, may further include a lower guide apparatus having a translating element operatively joined to a guide element for translating movement of the translating element relative to the guide element. The attachment points at the lower ends of either the lower outer links, or the left and right side links of the lower inner frame, are rotatably connected to the translating element of the lower guide apparatus. The lower guide apparatus may include a pair of guide rods spaced from, and extending parallel to one another.

In some forms of the invention, the attachment points at the lower ends of the lower outer links of a scissors lift mechanism may be rotatably attached to the unitized chassis, and the attachment points at the lower ends of the right and left side links of the lower inner frame of the scissors mechanism may be attached to the translating element of the lower guide apparatus, with the guide element of the lower guide apparatus being attached to the chassis in a manner constraining the lower ends of the lower inner frame to translate along the longitudinal axis of the chassis, as the scissors mechanism moves between a fully raised and a fully lowered position of the scissors mechanism with respect to the chassis.

A scissors lift mechanism, according to the invention, may further include a linear actuator operatively attached between the chassis and the translating element of the lower guide apparatus for moving the translating element in a longitudinal direction along the guide element. The linear actuator may have first end thereof rotatably attached to the chassis and a second end thereof rotatably attached to the lower inner frame, with the actuator providing relative linear movement between the first and second ends of the linear actuator. In some forms of the invention, the linear actuator may be powered. A powered linear actuator, according to the invention, may include a hydraulic cylinder for moving the first and second ends of the linear actuator relative to one another.

A scissors mechanism, according to the invention, may further include an upper guide apparatus having a translating element operatively joined to a guide element for translating movement of the translating element of the upper guide apparatus relative to the guide element of the upper guide apparatus. The upper ends of either the upper outer links, or the left and right side links of the upper inner frame, may be rotatably connected to the translating element of the upper guide apparatus. The guide element of the upper guide apparatus may include a pair of guide rods spaced from, and extending parallel to one another.

The scissors mechanism, according to the invention, may further include a seat mounting plate, with the upper ends of the right and left side links of the upper inner frame being attached to the seat mounting plate, and the upper ends of the upper outer links being rotatably attached to the translating element of the upper guide apparatus, with the guide element of the upper guide apparatus being attached to the seat mounting plate in a manner constraining the upper ends of the upper inner frame to translate along the longitudinal axis of the chassis, as the scissors mechanism moves between a fully raised and a fully lowered position of the seat mounting plate with respect to the chassis.

A seat mounting plate, according to the invention, may be a unitized structure having a substantially planar mounting base defining a periphery of the mounting plate, a longitudinal axis of the mounting base, and a transverse axis of the mounting plate extending substantially perpendicular to the longitudinal axis of the mounting plate. The seat mounting plate may also include a peripheral mounting plate side wall, having an edge thereof joined as a unitized structure to the periphery of the mounting base, and having a width thereof extending substantially orthogonally to the mounting plate. The peripheral mounting plate side wall may also include a stiffening flange.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective top view of an exemplary embodiment of a powered wheelchair, according to the invention, with a seat of the wheelchair in a raised position.

FIG. 2 is a bottom perspective view of the exemplary embodiment of the wheelchair of FIG. 1, with the seat in a raised position.

FIGS. 3 and 4 are left side and front orthographic views, respectively, of the exemplary embodiment of the wheelchair shown in FIGS. 1 and 2, with the seat in a raised position.

FIGS. 5 and 6 are top and bottom perspective views, respectively of the exemplary embodiment of the wheelchair shown in FIG. 1, with the seat in a fully lowered position.

FIGS. 7 and 8 are front and right side orthographic views, respectively of the exemplary embodiment of the wheelchair shown in FIG. 1, with the seat in a fully lowered position.

FIG. 9 is an orthographic bottom view of the exemplary embodiment of the wheelchair shown in FIG. 1, with various components removed to illustrate various construction and connection details of the exemplary embodiment

FIG. 10 is a schematic illustration of the connections of a tilt sensor and controller within the exemplary embodiment of the wheelchair shown in FIG. 1.

FIG. 11 is a top perspective view of a unitized chassis of the exemplary embodiment of the wheelchair shown in FIG. 1.

FIG. 12 is an orthographic bottom view of the unitized chassis of FIG. 11.

FIG. 13 is a bottom perspective view of the unitized chassis of FIG. 11.

FIG. 14 is a partial cut away bottom perspective view of the unitized chassis of FIG. 11.

FIG. 15 is a partially cut away top perspective view of a seat mounting plate of a scissors lift mechanism, of the exemplary embodiment of the wheelchair shown in FIG. 1.

FIG. 16 is a top orthographic view of a guide apparatus of a scissors lift mechanism of the exemplary embodiment of the wheelchair of FIG. 1.

FIG. 17 is a sectional orthographic view, taken along line 17-17 of FIG. 16, illustrating various internal features of the components of the guide apparatus of FIG. 16.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

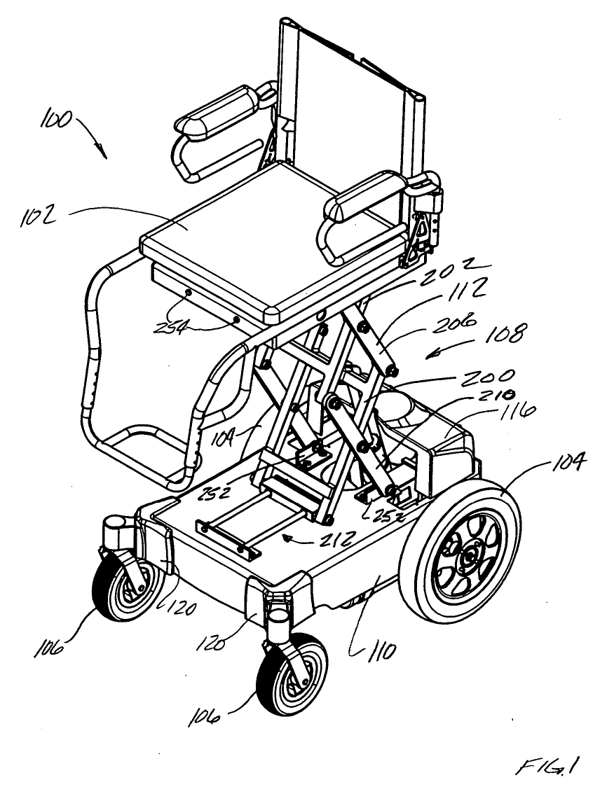

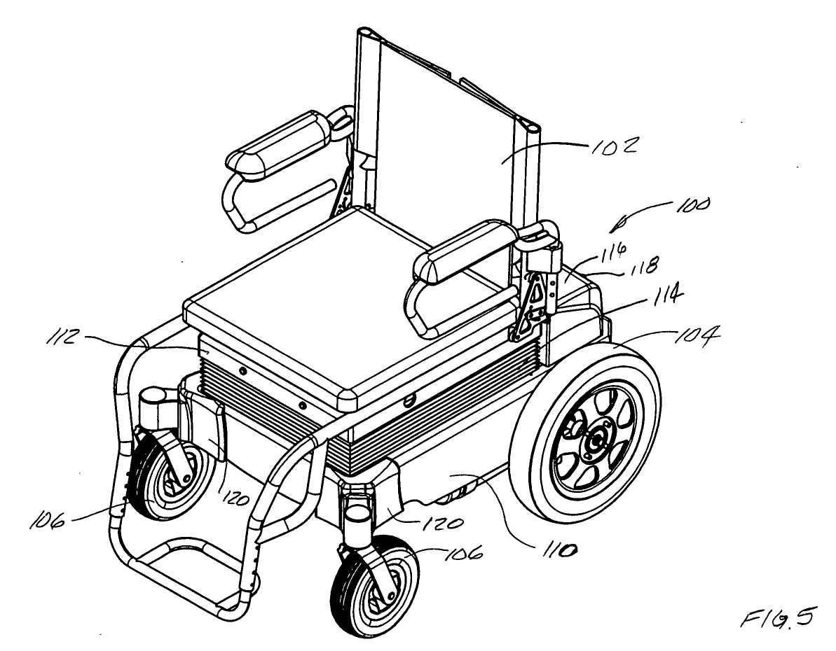

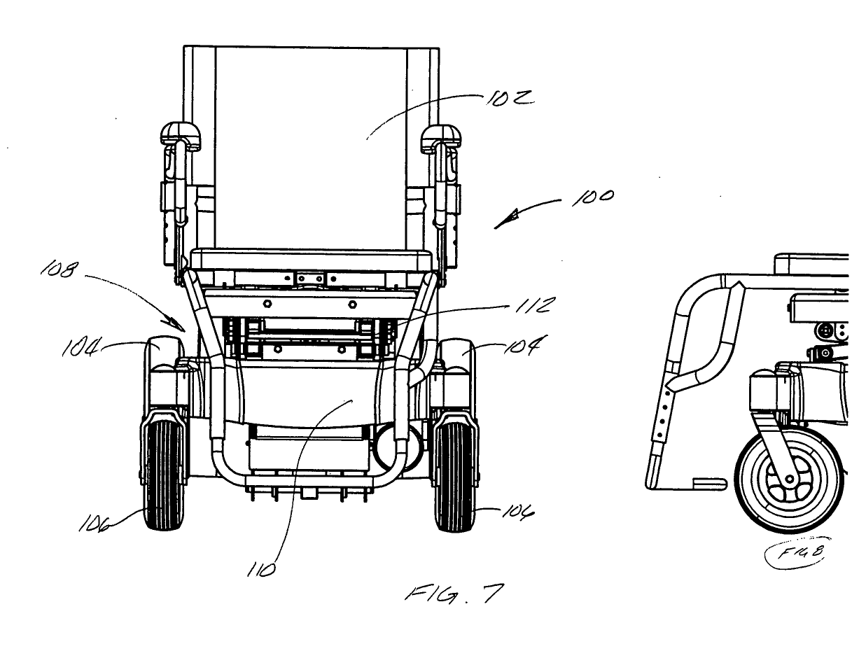

FIGS. 1-8 show an exemplary embodiment of a powered wheelchair 100, according to the invention, having a seat 102 operatively joined to a pair of rear-mounted drive wheels 104 and a pair of front-mounted casters 106, by a wheelchair support apparatus 108 which includes a unitized chassis 110 and a scissors lift mechanism 112. FIGS. 1-4 illustrate the wheelchair 100, from various angles, with the scissors lift mechanism 112 in a fully raised position. FIGS. 5-8 show the powered wheelchair 100, from various angles, with the scissors lift mechanism 112 in a fully lowered position.

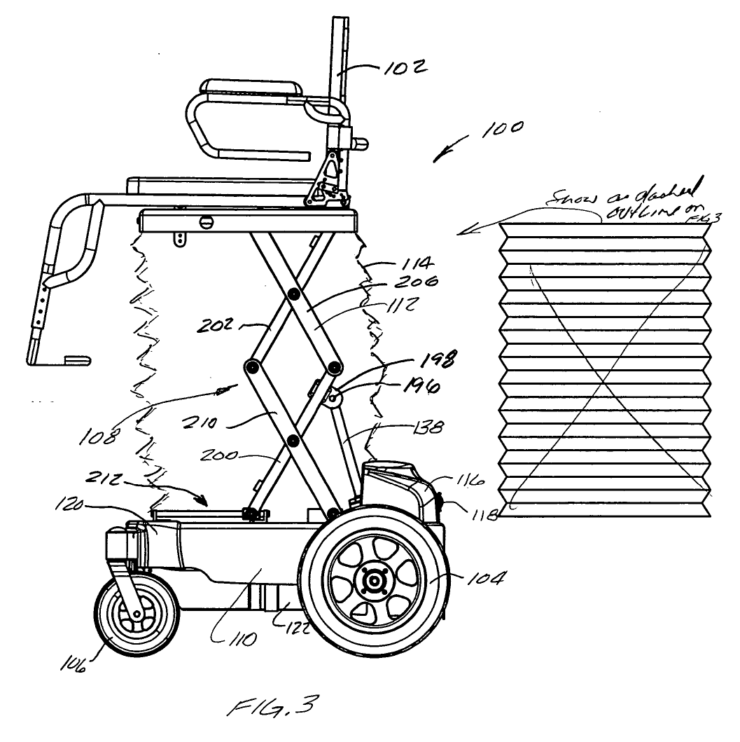

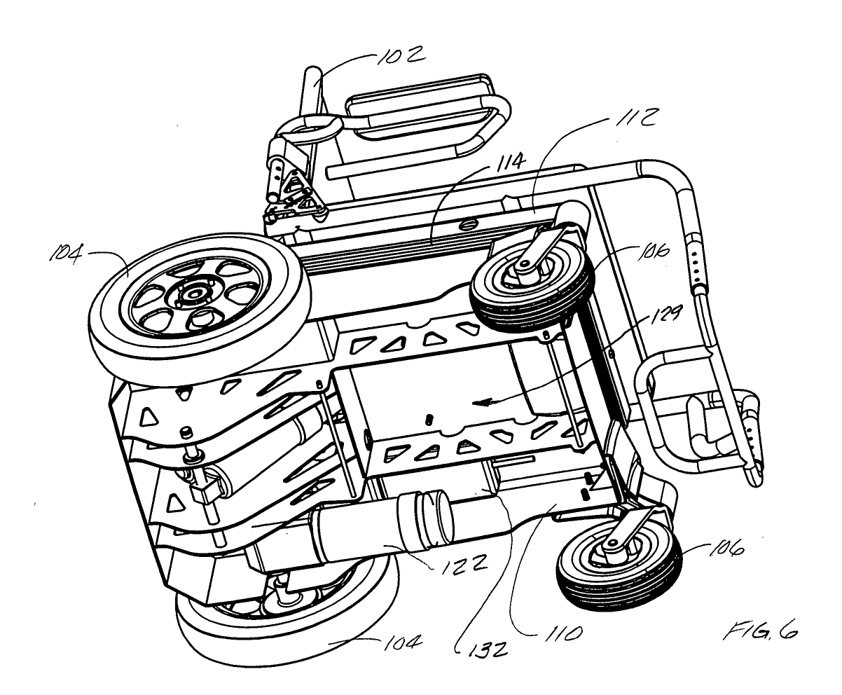

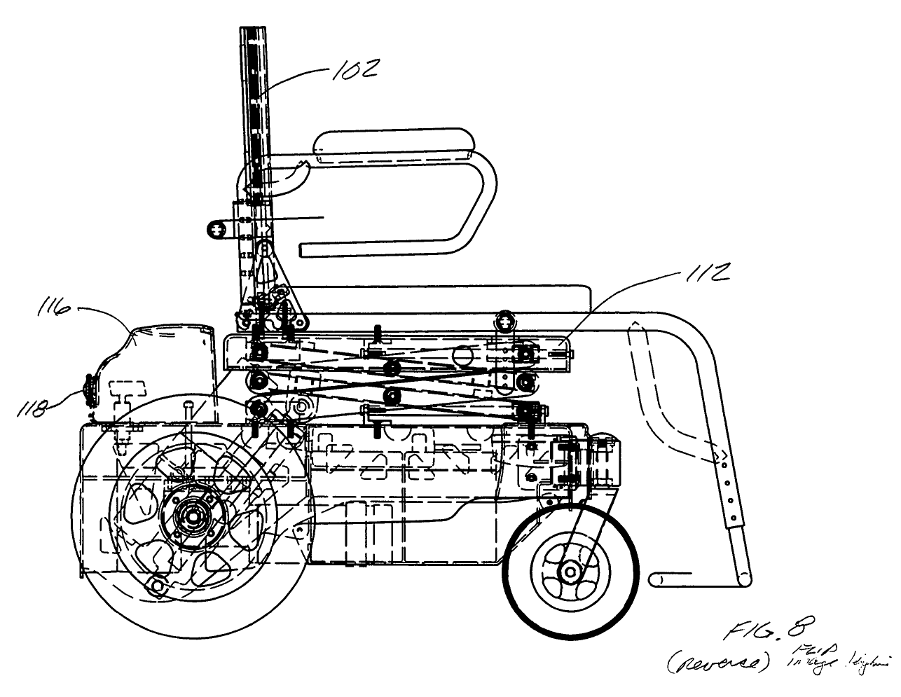

As shown by dashed lines in FIG. 3, and solid lines in FIGS. 5 and 6, the exemplary embodiment of the powered wheelchair 100 also includes a bellows-like protective shroud 114 around the scissors mechanism 112. A rear shroud 116 is attached at the top rear of the chassis 110 as a partial protective cover for an actuator, to be described below, and to provide mounting for tail and directional lights, as best seen in FIG. 8. Protective/decorative covers 120 are also provided at the two front corners of the chassis 110.

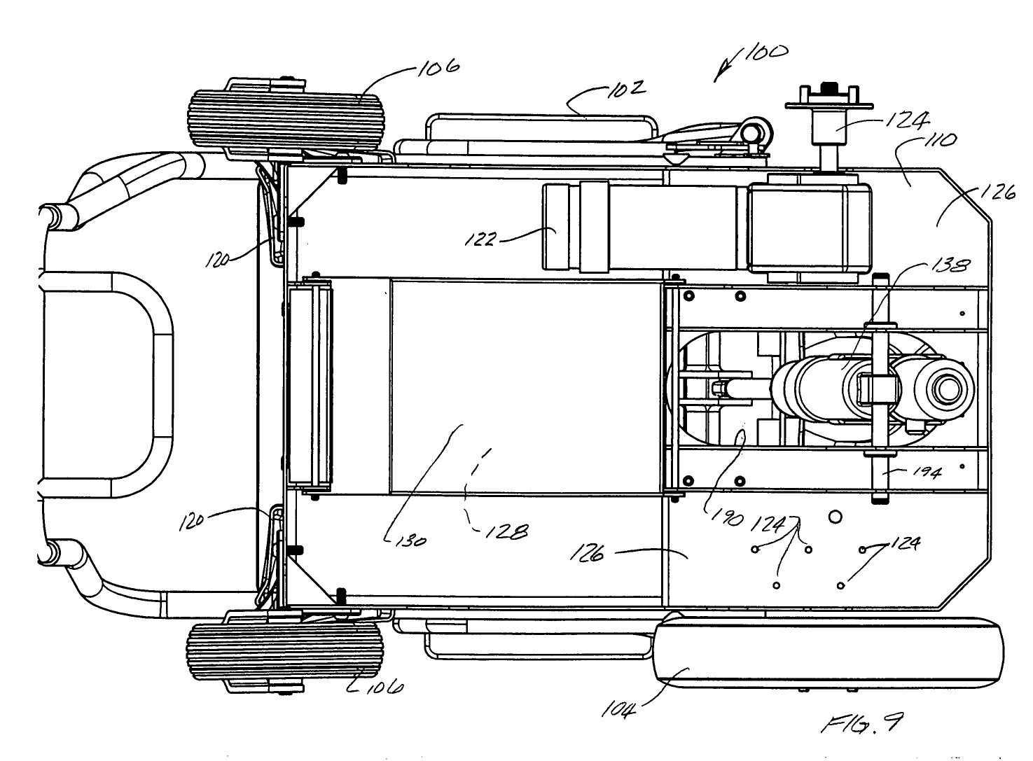

As shown in FIG. 9, each of the rear wheels 104 is connected to be driven directly by a drive motor assembly 122, through an operative connection 124. The drive motor assemblies 122 are fastened directly to the chassis 110 by a series of bolts passing through holes 124 in secondary plates 126 of the chassis 110. For clarity of illustration, only the left drive motor assembly 122 and operative connection 124 are shown in FIG. 9, but it will be understood, by those having skill in the art, that each of the drive wheels 104 is similarly connected by an operative connection 124 to a right drive motor assembly 122 bolted to a secondary base 126 on the right side of the chassis 110 by bolts passing through holes 124 in the secondary base 126.

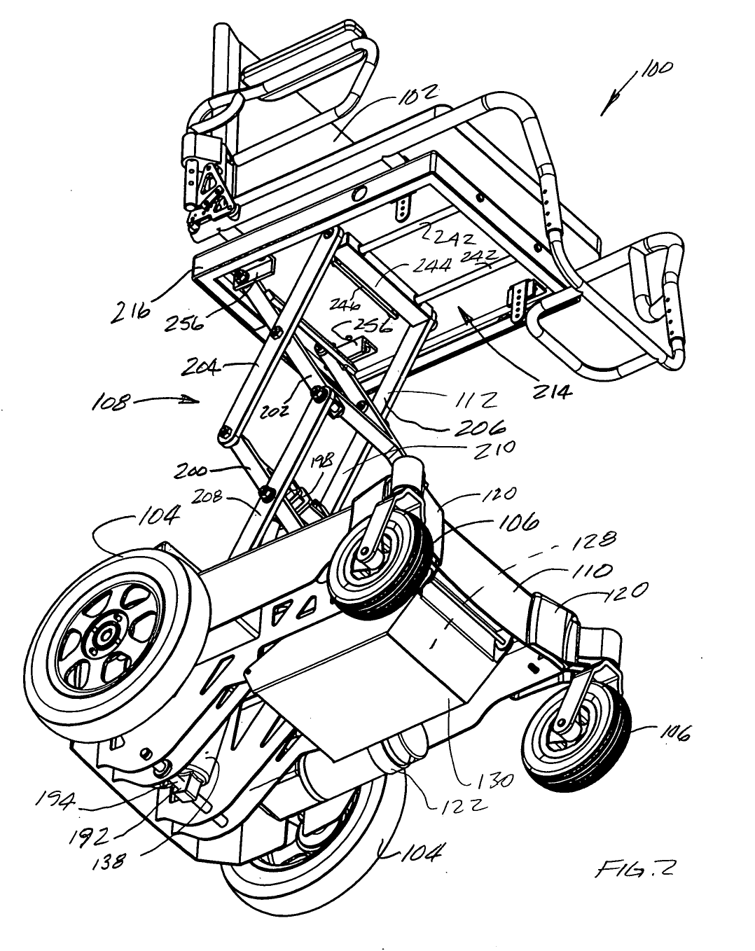

As shown in FIGS. 2, 6 and 9, the powered wheelchair 100 of the exemplary embodiment also includes a battery 128 mounted centrally within a battery compartment 129 of the unitized chassis 110, and a battery cover 130 for closing the battery compartment 129. As shown in FIG. 6, the exemplary embodiment of the powered wheelchair 100 further includes a battery charger/power supply 132, mounted on an underside of the unitized chassis 110 and operatively connected between the battery 128 and the drive motor assemblies 122.

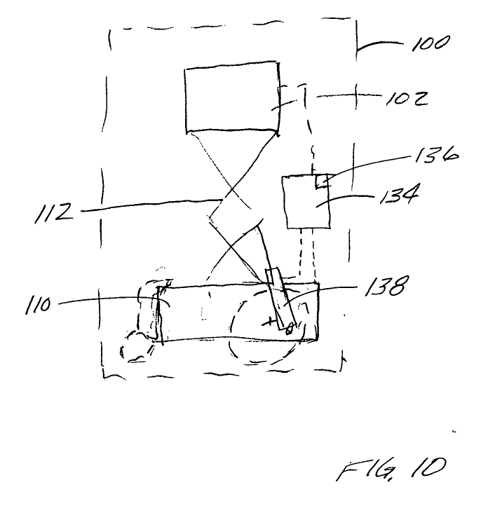

As illustrated schematically in FIG. 10, the exemplary embodiment of the powered wheelchair 100 also includes a controller 134 having a tilt sensor 136 for sensing an angle of tilt, in one or more directions, of the wheelchair 100. The tilt sensor 136 and controller 134 are operatively connected between the seat 102, the unitized chassis 110 and a linear actuator 138, to be described in more detail below of the scissors lift mechanism 112 for precluding extension of the lift mechanism if the sensed angle of tilt exceeds a predetermined safe angle of tilt. The controller 134, of the exemplary embodiment, also retracts the scissors lift mechanism to the fully lowered position, at a controlled rate of retraction, if the lift mechanism is extended when the tilt sensor 136 detects that the angle of tilt of the wheelchair 100 exceeds the predetermined safe angle of tilt. The predetermined safe angle of tilt, in the controller 134 of the exemplary embodiment, is a function of the degree of extension of the lift mechanism 112 from the fully lowered position, such that the predetermined safe angle of tilt that is allowable will be greater when the seat 102 is closer to the chassis 110 then when the seat 102 is extended further away from the chassis 110 toward the fully raised position of the seat 102. In various embodiments of the invention, the tilt sensor 136 and controller 134 may be mounted together, or separately, at various locations on the various components of the wheelchair 100. The controller 134 may also be programmed to allow different predetermined safe angles of tilt in various directions, i.e., the safe angle of tilt allowed in a fore and aft direction may be different from a safe angle of tilt allowed in a sized-to side direction, or in various directions therebetween.

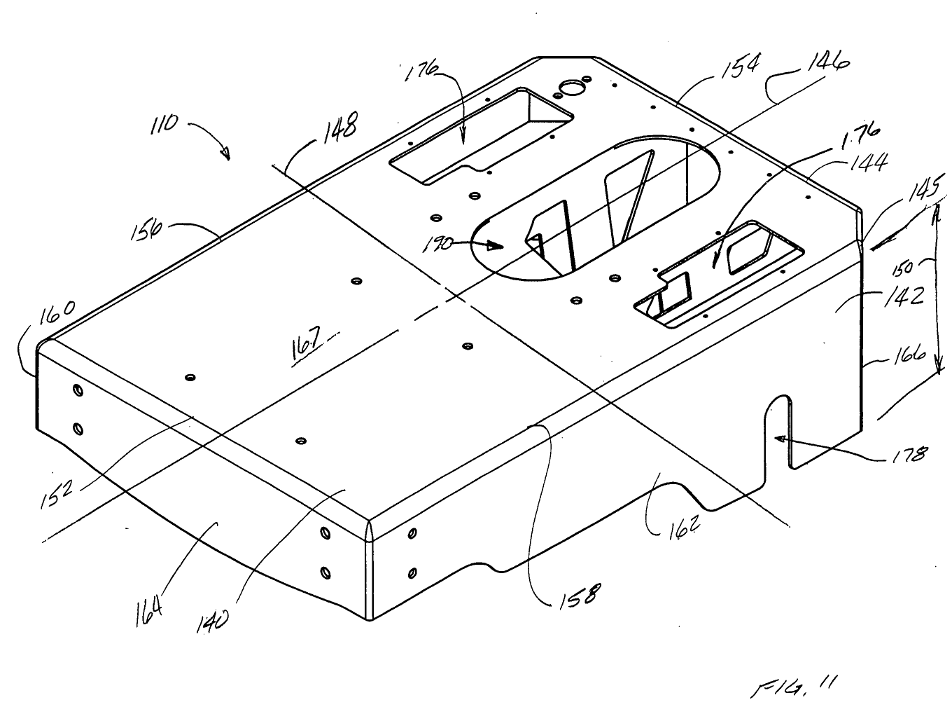

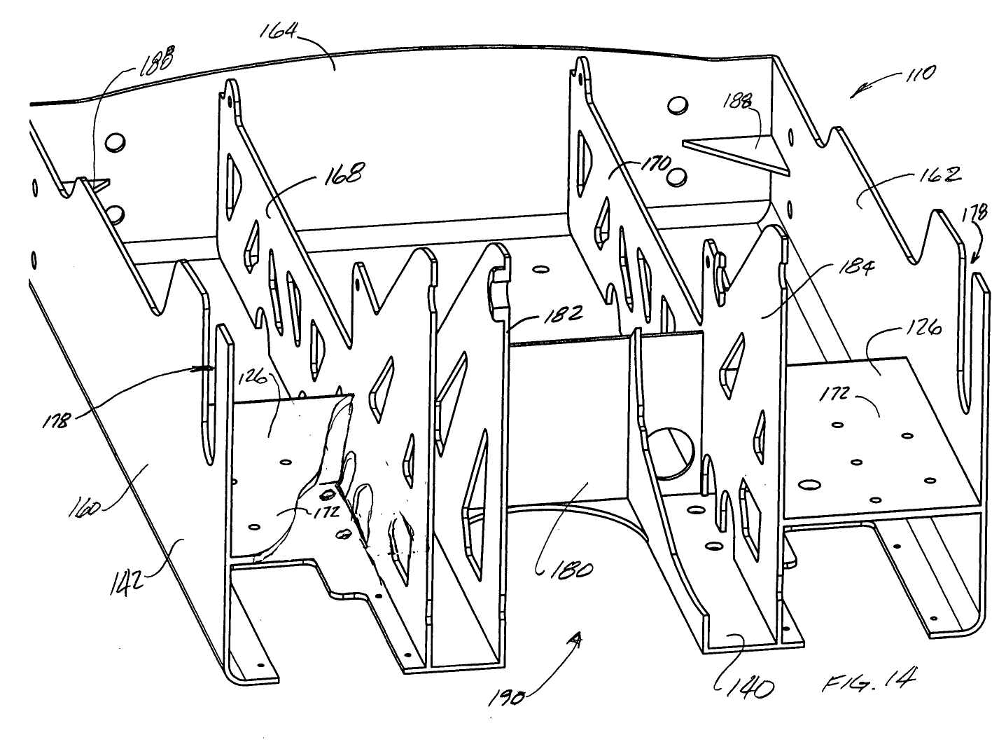

FIGS. 11-14 show the unitized chassis 110 of the exemplary embodiment of the powered wheelchair 100, in various orientations, to aid in understanding of the construction of the unitized chassis 110. The unitized chassis 110 includes a substantially planar base plate 140 and a peripheral side plate 142. The base plate 140 defines a periphery 144 of the base plate 140, a longitudinal axis 146 of the chassis 110, and a transverse axis 148 of the chassis 110 extending substantially perpendicular to the longitudinal axis 146 of the chassis. The peripheral side plate 142 has an upper edge thereof joined as a unitized structure to the periphery 144 of the base plate 140, and a width 150 thereof extending substantially orthogonally base plate 140 of the unitized chassis 110. The width 150 of the peripheral side plate 142 varies, in the exemplary embodiment, as the peripheral side plate 142 extends around the entire periphery 144 of the base plate 140.

In the exemplary embodiment, the base plate 140 of the chassis 110 is substantially rectangular in shape, with the periphery 144 thereof forming longitudinally spaced substantially parallel front and rear edges 152, 154 of the base plate 140, and transversely spaced, substantially parallel, right and left edges 156, 158 of the base plate 140. The peripheral side plate 142 of the exemplary embodiment of the unitized chassis 110 includes right and left transversely spaced portions 160 162 which extend substantially longitudinally along the right and left sides of the chassis 110, and front and rear longitudinally spaced portions 164, 166 thereof which extend substantially transversely across the front and rear of the unitized chassis 110 respectively. The right and left longitudinally spaced portions 160, 162 of the peripheral side plate 142 are joined into a unitized structure with the base plate 140 along the front and rear edges 152, 154 of the base plate 140, and the right and left transversely spaced portions 160, 162 of the peripheral side plate 142 are joined in a unitized structure to the base plate 140 along the right and left edges 156, 158, respectively, of the base plate 140. Adjoining corners of the transversely and longitudinally spaced portions 160, 162, 164, 166 of the peripheral side wall 142 of the chassis 110 are also joined together to form a unitized structure.

By virtue of the above described orientation and connection of the base plate 140 and peripheral side plate 142, when the chassis 110 is oriented for operative attachment of the seat 102 and wheels 104, 106 of the wheelchair 100, the base plate 140 and peripheral side plate 142 of the chassis 110 form an open-bottom box-shaped shell, with the base plate 140 forming a top surface 167 of the chassis 110, and the peripheral side plate 142 depending substantially downward from the base plate 140.

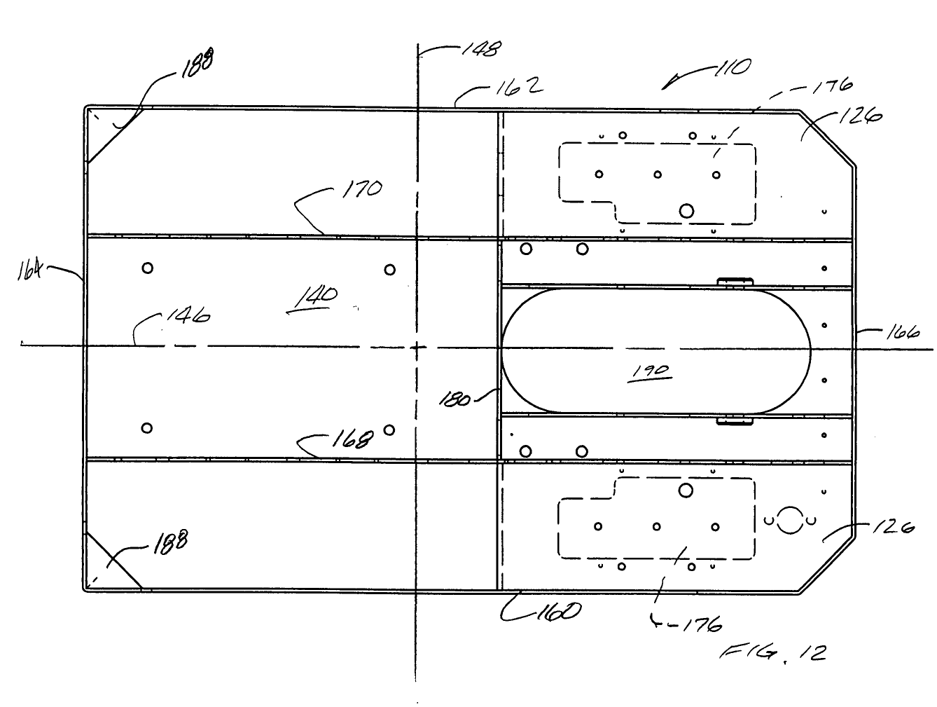

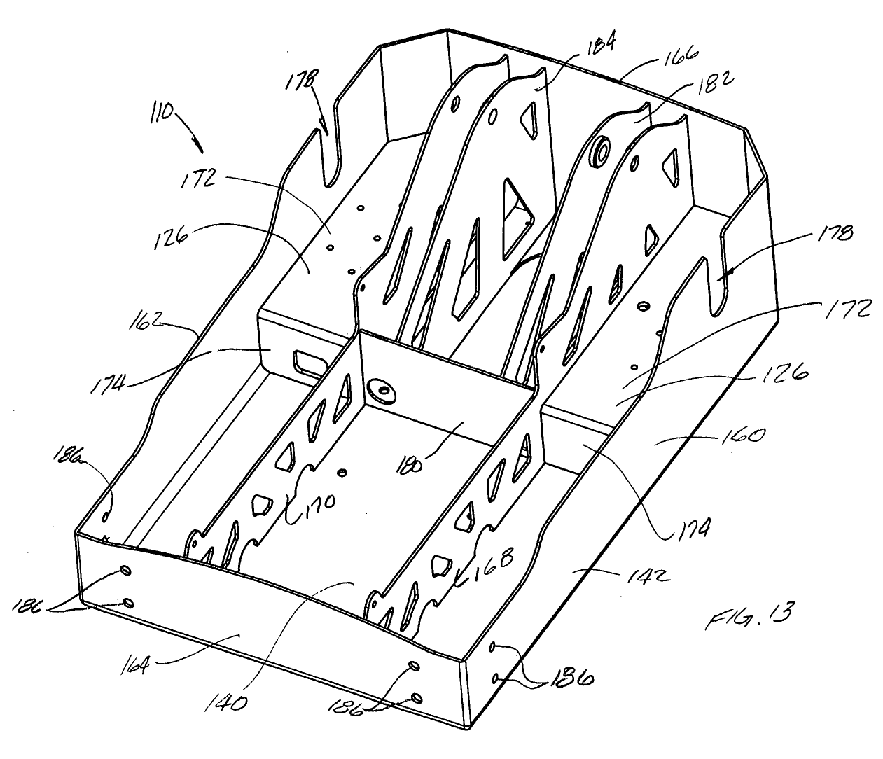

As shown in FIGS. 12 and 13, the unitized chassis 110, of the exemplary embodiment, includes first and second longitudinal ribs 168, 170 disposed inboard of the right and left transversely spaced portions 160, 162 of the peripheral side plate 142, and centered generally about the longitudinal axis 146 of the unitized chassis 110. The first and second longitudinal ribs 168, 170 are integrally joined as a unitized structure to the base plate 140 and to the front and rear longitudinally spaced portions 164, 166 of the peripheral side plate 142.

As shown in FIGS. 12-14, the secondary base plates 126, in the exemplary embodiment of the chassis 110 include a horizontal portion 172 thereof, which is offset from the base plate 140, and joined as a unitized structure to both the peripheral side plate 142 and an adjacent one of the first and second longitudinal ribs 168, 170. The base plates 126, of the exemplary embodiment, are substantially L-shaped and include a vertical portion 174, extending from the forward end of the horizontal portion 172 of the secondary base plate 126. The vertical portion 174 of the secondary base plate is joined as a unitized structure to the base plate 140, the peripheral side plate 142 and an adjacent one of the first and second longitudinal ribs 168, 170.

As best seen in FIG. 11, the base plate 140 of the unitized chassis 110, of the exemplary embodiment, includes a pair of access holes 176, to facilitate attachment of the drive motor assemblies 122 to the horizontal portions 172 of the secondary base portion 126 of the chassis 110.

As shown in FIG. 11, the right and left transversely spaced portions 160, 162 of the peripheral side plate 142 of the chassis 110 include downwardly opening slots 178 therein for passage therethrough of the operative connection 124 between the drive motor assemblies 122 and the driven wheels 104.

As shown in FIGS. 12-14, the chassis 110 also includes an interior transverse rib extending between the first and second longitudinal ribs 168, 170 and joined as a unitized structure to the first and second longitudinal ribs 168, 170, and the base plate 140 of the chassis 110. An additional pair of third and fourth longitudinal ribs 182, 184 are disposed inboard of the first and second longitudinal ribs 168, 170 respectively, and are integrally joined as a unitized structure to the interior transverse rib 180, the base plate 140, and the rear longitudinally spaced portion 166 of the peripheral side wall 142.

A series of mounting holes 186 are provided at the forward corners of the unitized chassis 110 for a bolted attachment of the front mounted casters 106. Comer gussets 188 are integrally joined to the inside surfaces of the peripheral side wall, at the front corners of the chassis 110, and the rear corners of the chassis 110 are angled to provide additional stiffness to the unitized chassis 110. The base plate 140 of the chassis 110 also includes a clearance hole 190 for passage therethrough of the linear actuator 138 of the scissors lift mechanism 112, in a manner described in more detail below and best seen in FIG. 9.

A unitized chassis, according to the invention, may be fabricated by a variety of methods, and from a variety of materials. In the unitized chassis 110 of the exemplary embodiment, a welded construction is used. A blank cut from a single sheet of aluminum includes the base plate 140, the right and left portions 160, 162, and front and rear portions 164, 166 of the peripheral side wall 142 of the chassis 110. The right, left, front, and rear portions 160, 162, 164, 166 are all bent perpendicularly in the same direction from the base 140 portion of the blank, and the adjoining corners of the right, left, front, and rear portions 160, 162, 164, 166 of the blank are welded to one another to form the peripheral side wall 142 of the chassis 110, resulting in the open-bottomed box-like shell of the chassis 110. The first through fourth longitudinal ribs 168, 170, 182, 184, the interior transverse rib 180, the secondary bases 126, and the corner gussets 188 are then positioned inside of the shell and welded to the shell, and one another, to form the completed unitized chassis 110 of the exemplary embodiment of the powered wheelchair 100. To facilitate fixturing and manufacture, the internal components of the chassis 110 include tabs (not shown) at various points along their interface with the shell, which slide into corresponding slots (not shown) in the shell of the chassis 110 to facilitate fabrication.

Those having skill in the art will recognize that a unitized chassis, according to the invention, may be fabricated in a number of different ways and from a variety of materials other than aluminum. For example, the unitized chassis 110 of the exemplary embodiment can alternatively be fabricated as a thin-wall aluminum casting, rather than as a welded assembly. A combination of investment casting and welding can also be utilized. In embodiments of the invention utilizing non-metallic materials, such as plastic or composites, a unitized chassis, according to the invention, may be fabricated by a variety of known molding and/or joining techniques. For a unitized chassis, according to the invention fabricated from either metallic or non-metallic materials, or from a combination of various types of materials, the integral joints between various components forming the unitized structure may also include the use of adhesive bonding, for example.

As shown in FIGS. 1-4, the scissors lift mechanism 112 of the wheelchair support apparatus 108, of the exemplary embodiment of the powered wheelchair 100, includes a plurality of operatively connected links, and a linear actuator 138 having a first end 192 thereof operatively attached to the chassis 110 by an actuator attachment rod 194 which passes through holes in the first through fourth longitudinal ribs 168, 170, 182, 184, in the manner shown in FIGS. 2, 4 and 9. A second end 196 of the linear actuator 138 is pivotably attached to a bracket 198 extending from one of the links, in the form of a lower inner frame 200 of the scissors lift mechanism 112. In the exemplary embodiment, the linear actuator is a hydraulic cylinder, having an attached electric motor driven pump for supplying pressurized hydraulic fluid to the hydraulic cylinder for selectively extending and contracting the scissors lift mechanism 112 between the fully raised and fully lowered position of the seat 102 with respect to the chassis 110.

In addition to the lower inner frame 200, the scissors lift mechanism 112 of the exemplary embodiment also includes: an upper inner frame 202; right and left outer upper links 204, 206; right and left lower outer links 208, 210; a lower guide apparatus 212; an upper guide apparatus 214; and a seat mounting plate 216 of unitized construction.

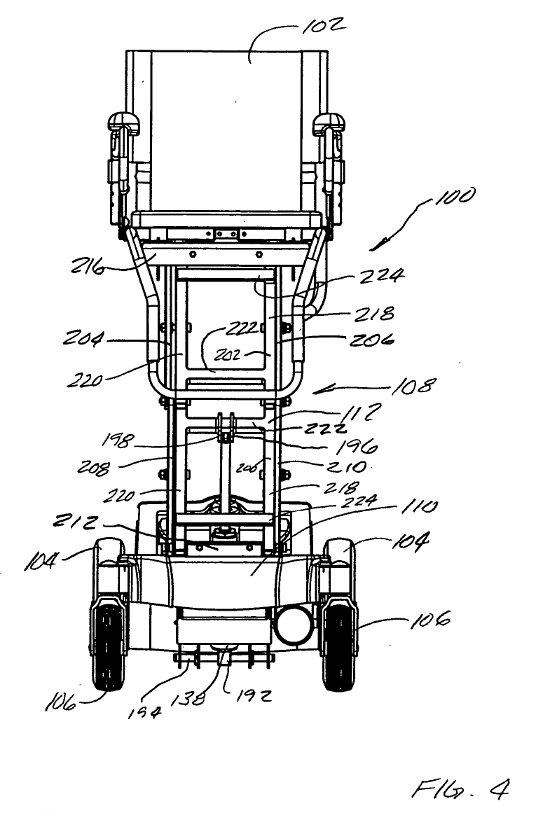

As shown in FIG. 4, the upper and lower inner frames 200, 202 each include left and right side links 218, 220 joined into a unitized structure by a non-protruding cross member 222. In the exemplary embodiment, the left and right side links 218, 220 and the cross member 222 of the upper and lower inner frames 200, 202 are fabricated from square tubing joined into a unitized structure by welding the cross members 222 between the left and right side links 218, 220. The cross members 222 are positioned and connected to the left and right side links 218, 220 in such a manner that the upper and lower facing surfaces (when the seat is in a fully lowered position) of the cross members 222 are flush with the upper and lower surfaces of the left and right side links 218, 220 of the upper and lower inner frames 200, 202. Having the cross member 222 joined in this manner, facilitates contraction of the scissors lift mechanism 112 to a minimal height when the seat 102 is in the fully lowered position.

In the exemplary embodiment, an additional cross bar 224, of solid rectangular shaped material, is also welded to the left and right side links 218, 220 of the upper and lower inner frames 200, 202, to provide additional rigidity and strength to the scissors lift mechanism 112. The upper and lower inner frames 200, 202 of the scissors lift mechanism 112, of the exemplary embodiment, are essentially identical to one another, to facilitate manufacturing and reduce inventory, except for the addition of the bracket 198 to the cross member 222 of the lower inner frame 202 for attachment of the second end 196 of the linear actuator 138.

The right and left upper outer links 204, 206 are rotatably attached at their mid-points to the mid-points of the left and right side links 218, 220 of the upper inner frame 202. In similar fashion, the left and right lower outer links 208, 210 are rotatably attached at their respective mid-points to the left and right side links 218, 220 of the lower inner frame 200. The upper ends of the left and right lower outer links 210, 212 are rotatably attached to the lower ends of the left and right side links 218, 220 of the upper inner frame 202. The lower ends of the left and right upper outer links 206, 204 are rotatably attached to the upper ends of the left and right side links 218, 220 of the lower inner frame 200.

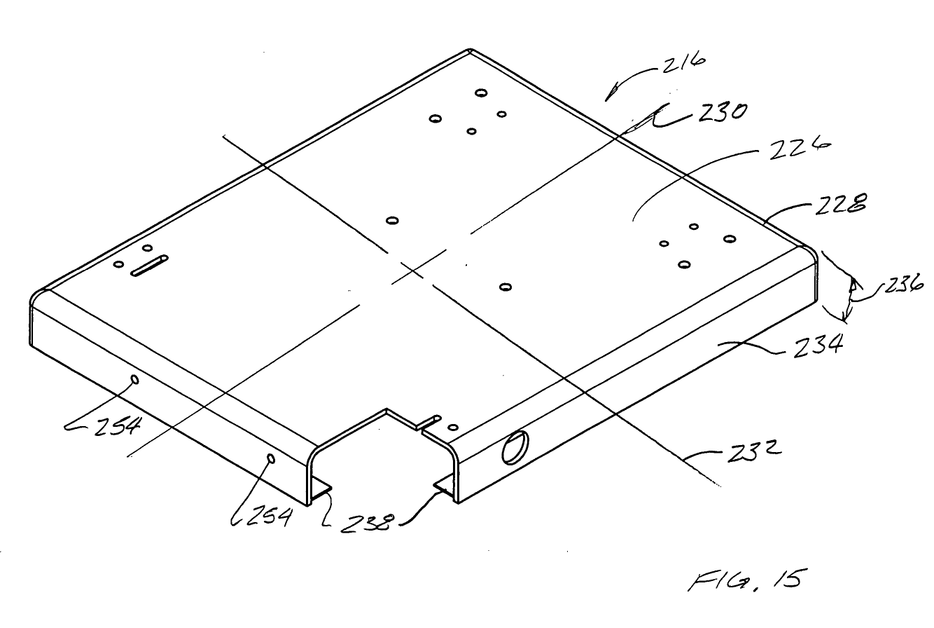

As shown on FIG. 15, the seat mounting plate 216, of the exemplary embodiment, is a unitized structure having a substantially planar mounting base 226 defining a periphery 228 of the mounting base, a longitudinal axis 230 of the mounting plate, and a transverse axis 232 of the mounting plate 216 extending substantially perpendicular to the longitudinal axis of the mounting plate 216. The seat mounting plate 216, of the exemplary embodiment, also includes a peripheral mounting plate side wall 234, having an upper edge thereof joined as a unitized structure to the periphery 228 of the mounting base 226, and having a width 236 thereof extending substantially orthogonally to the mounting base 226. Adjoining corners of the various portions of the peripheral mounting plate side wall 234 are integrally joined into a unitized structure, in the same manner as described above with regard to the unitized chassis 110. The unitized seat mounting plate 216 of the exemplary embodiment also includes a stiffening flange 238 extending inward from the peripheral mounting plate side wall 234, as shown in the partial cutaway of one corner of the seat mounting plate 216 in FIG. 15.

The unitized seat mounting plate 216, of the exemplary embodiment, may be fabricated in a variety of forms and from a variety of materials, in the same manner as described above with regard to fabrication of a unitized chassis, in accordance with the invention.

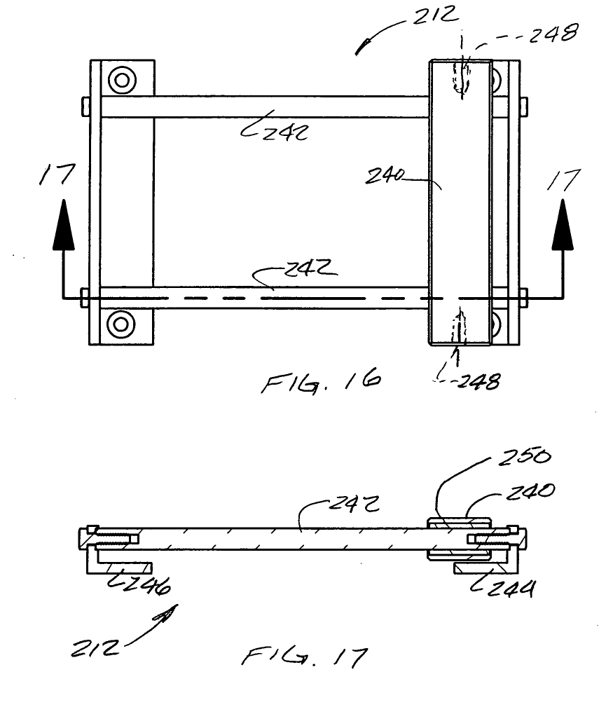

As shown in FIGS. 16 and 17, the lower guide apparatus 212 includes a translating element 240, operatively joined to a guide element in the form of two guide rods 242 which are spaced from and extend parallel to one another between front and rear support brackets 244, 246, for translating movement of the translating element 240 relative to the guider rods 242. Specifically, the translating element 240 is a substantially solid bar having threaded attachments 248 at opposite ends thereof for rotatable attachment to the lower ends of the right and left side links 220, 218 of the lower inner frame 200. The translating element further includes a pair of linear bearings 250 for close-tolerance passage therethrough of the guide rods 242. As will be understood, by those having skill in the art, when the lower guide apparatus 212 is attached to the upper surface of the unitized frame 110 of the exemplary embodiment, as illustrated in FIG. 1, with the guide rods 242 extending substantially parallel to the longitudinal axis 146 of the chassis 110, the lower ends of the inner frame 200 rotatably attached to opposite ends of the translating element 240, and the lower ends of the left and right lower outer links 210, 208 rotatably attached to the unitized chassis 110 by mounting brackets 252, the lower guide apparatus 212 will constrain the lower end of the lower inner frame 200 to move fore and aft along the longitudinal axis 146 as the linear actuator 138 contracts and extends.

Construction and mounting of the upper guide apparatus 214 to the seat mounting plate 216 is essentially identical to the construction and mounting described above for the lower guide apparatus 212, with the exception that the front support bracket 244 of the lower guide apparatus 212 is eliminated in the upper guide apparatus 216, with the forward ends of the guide rods 242 of the upper guide apparatus being fastened directly to the peripheral mounting plate side wall 234 through a pair of holes 254 extending through the front of the peripheral mounting plate side wall 234.

The upper ends of the right and left upper outer links 204, 206 are attached to opposite ends of the translating element of the upper guide apparatus, and the upper ends of the upper inner frame 202 are rotatably attached to brackets 256 extending from the bottom surface of the seat mounting plate 216, in such a manner that the translating element 244 of the upper guide apparatus 214 is constrained to move fore and aft the longitudinal axis 146, 230 of the chassis 110 and seat mounting plate 216 as the linear actuator 138 contracts and extends.

In practicing the invention, all of the rotatable connections between the various elements of the scissors lift mechanism 112 are preferably closely toleranced and aligned to minimize clearance and any movement other than rotation in the joints. Those having skill in the art will readily recognize that, by virtue of the construction and connection of the lower and upper inner frames 200, 202, and other elements of the scissors lift mechanism, such as the upper and lower guide apparatuses 212, 214, in conjunction with the structurally non-flexing unitized chassis 110 and seat mounting plate 216, the exemplary embodiment, of the powered wheelchair 100 may be safely operated with the seat 102 in the fully raised position with substantially less movement and instability than occurred in prior wheelchairs having a lifting mechanism. It will be further recognized, that, by virtue of the construction and relative location of the various components of the exemplary embodiment of the powered wheelchair 100, the center of gravity of the powered wheelchair 100 is very low, with reference to the surface supporting the wheelchair 100, to thereby also further enhance stability of the wheelchair 100. It will be yet further noted, by those having skill in the art, that the relative location of attachment points of the scissors lift mechanism 112 with respect to the drive wheels 104 and casters 106, and the manner in which the scissors lift mechanism 112 is attached to the seat mounting plate 216 also enhance stability of the exemplary embodiment of the powered wheelchair 100.

Attachment of the linear actuator 138, in the manner described above, and as shown in the drawings, with the first end 192 of the linear actuator 138 located below and behind the drive wheels 104 allows a relatively long stroke in the linear actuator 138, and, provides an advantageous alignment of the actuator 138 with the remainder of the scissors lift mechanism 112 which reduces the force that is required to be produced the linear actuator in moving the seat from the fully lowered to the fully raised position.

By virtue of the various aspects of the invention described above, the inventor has constructed a wheelchair, essentially identical to the exemplary embodiment of the powered wheelchair 100 described herein, which is substantially lighter in weight than prior powered wheelchairs performing similar functions. Specifically, the wheelchair constructed by the inventor weighs approximately 150 to 170 pounds, depending on the particular seat configuration and accessories selected, which is capable of carrying and lifting an individual weighing 325 pounds. Prior powered wheelchairs offering similar functionally weigh 225 to 400 pounds.

Those having skill in the art will recognize that, although the invention has been described herein with regard to the exemplary embodiment of the powered wheelchair 100, various aspects and features of the invention may be provided in a variety of other forms in alternate embodiments of the invention. For example, other embodiments of the invention may utilize other types of linear actuators, such as ball-screw-type actuators, for example. The linear actuator may also be connected in a different fashion, from that described above, such as between the chassis and the translating element of either upper or lower guide apparatus of a scissors lift mechanism, according to the invention. Specifically, a linear actuator, such as a ball-screw or hydraulic or pneumatic cylinder, may be operatively attached between the translating element and one of the mounting brackets of the upper and/or lower guide apparatuses of a scissors lift mechanism, according to the invention. The guide rods of a guide apparatus, according to the invention may also take the form of a rotatable screw engaging a nut mounted in a translating element of a scissors lift mechanism, according to the invention.

Those having skill in the art will also recognize that the invention may be practiced with lift mechanisms of a type other than the scissors lift mechanism described herein with regard to the exemplary embodiment and certain aspects of the invention.

Those skilled in the art will yet further recognize that the invention may also be practiced in non-powered wheelchairs, and in both powered and non-powered wheelchairs without a lift mechanism. A scissors lift mechanism, according to the invention may also incorporate a manually operable linear actuator rather than a powered linear actuator of the type described above.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A unitized chassis for operatively connecting a seat and wheels of a wheelchair, the chassis comprising:
a substantially planar base plate defining a periphery of the base plate, a longitudinal axis of the chassis, and a transverse axis of the chassis extending substantially perpendicular to the longitudinal axis of the chassis; and
a peripheral side plate, having an edge thereof joined as a unitized structure to the periphery of the base plate, and having a width thereof extending substantially orthogonally to the base plate.

2. The unitized chassis of claim 1, wherein, when the chassis is oriented for operative attachment of the seat and wheels of the wheelchair, the base plate and peripheral side plate of the chassis form an open-bottomed box-shaped shell, with the base plate forming a top surface of the chassis, and the peripheral side plate depending substantially downward from the base plate.

3. The unitized chassis of claim 2, further including at least one longitudinal rib integrally joined as a unitized structure to the base plate and disposed inboard of the peripheral side plate.

4. The unitized chassis of claim 3, wherein the longitudinal rib is integrally joined at one or both longitudinal ends thereof, as a unitized structure, to the peripheral side plate.

5. The unitized chassis of claim 4, further comprising, at least one secondary plate, which is offset from the base plate, and joined as a unitized structure to both the peripheral side plate and the longitudinal rib.

6. The unitized chassis of claim 5, wherein, the secondary plate is further joined as a unitized structure to the base plate.

7. The unitized chassis of claim 6, wherein, the base plate includes an opening therethrough for access through the base plate to the secondary plate.

8. The unitized chassis of claim 5, wherein:
the wheelchair further includes a motor for driving a driven wheel of the wheelchair, via an operative connection between the motor and the wheel;
the secondary plate includes attachment features for fixed operative attachment thereto of the motor; and
the peripheral wall is configured for passage therethrough of the operative connection between the motor and the driven wheel.

9. The unitized chassis of claim 7, wherein:
the wheelchair further includes a scissors lift mechanism operatively connecting the seat to the chassis, with the lift mechanism including a plurality of links and a linear actuator having a first end thereof operatively attached to the chassis and a second end thereof operatively attached to one of the links for selectively extending and contracting the scissors mechanism between a fully raised and a fully lowered position of the seat with respect to the chassis;

10. A wheelchair, comprising:
a seat;
wheels; and
a unitized chassis operatively connecting the seat and the wheels;
the chassis having a substantially planar base plate defining a periphery of the base plate, a longitudinal axis of the chassis, and a transverse axis of the chassis extending substantially perpendicular to the longitudinal axis; and
a peripheral side plate, having an edge thereof joined as a unitized structure to the periphery of the base plate, and having a width thereof extending substantially orthogonally to the base plate.

11. The wheelchair of claim 10, wherein, when the chassis is oriented for operative attachment of the seat and wheels of the wheelchair, the base plate and peripheral side plate of the chassis form an open-bottomed box-shaped shell, with the base plate forming top surface of the chassis, and the peripheral side plate depending substantially downward from the base plate.

12. The wheelchair of claim 11, further including at least one primary longitudinal rib integrally joined to the base plate and disposed inboard of the peripheral side plate.

13. The wheelchair of claim 12, wherein the primary longitudinal rib is integrally joined at one or both longitudinal ends thereof to the peripheral side plate.

14. The wheelchair of claim 13, further comprising, at least one secondary plate, which is offset from the base plate, and joined as a unitized structure to both the peripheral side plate and the primary longitudinal rib.

15. The wheelchair of claim 14, wherein, the secondary plate is further joined as a unitized structure to the base plate.

16. The wheelchair of claim 15, wherein, the base plate includes an opening therethrough for access through the base plate to the secondary plate.

17. The wheelchair apparatus of claim 16, further comprising:
a motor for driving a driven wheel of the wheels of the wheelchair, via an operative connection between the motor and the driven wheel;
the motor having a stationary portion thereof fixedly attached to the secondary plate; and
the peripheral side wall of the chassis being configured for passage therethrough of the operative connection between the motor and the driven wheel.

18. The wheelchair of claim 17, further comprising:
a lift mechanism operatively connecting the seat to the chassis;
the lift mechanism including a linear actuator having a first end thereof operatively attached to the chassis and a second end thereof operatively attached for selectively extending and contracting the lift mechanism between a fully raised and a fully lowered position of the seat with respect to the chassis.

19. The wheelchair of claim 18, further comprising, a controller including a tilt sensor for sensing an angle of tilt of the wheelchair, and precluding extension of the lift mechanism if the sensed angle of tilt exceeds a predetermined safe angle of tilt.

20. The wheelchair of claim 19, wherein the controller further retracts the lift mechanism to the fully lowered position, at a controlled rate of retraction, if the lift mechanism is extended when the tilt sensor detects that the angle of tilt of the wheelchair exceeds the predetermined safe angle of tilt.

21. The wheelchair of claim 20, wherein, the predetermined safe angle of tilt is a function of the extension of the scissors mechanism from the fully lowered position.

22. The wheelchair of claim 21, wherein, the predetermined safe angle of tilt is a function of the direction of the angle of tilt with respect to the wheelchair.

23. The wheelchair of claim 18, wherein, when the chassis is oriented for operative attachment of the seat and wheels of the wheelchair:
the base plate and peripheral side plate of the chassis form an open-bottomed box-shaped shell, with the base plate forming a top surface of the chassis, and the peripheral side plate depending substantially downward from the base plate;
the base plate of the chassis includes an actuator opening therein for passage therethrough of the actuator; and
the first end of the actuator is operatively attached to the chassis below the base plate.

24. The wheelchair apparatus of claim 23, wherein, the chassis further includes a secondary longitudinal rib integrally joined to the base plate and disposed inboard of the primary longitudinal rib, with the first end of the actuator being operatively attached to the secondary longitudinal rib.

25. The wheelchair of claim 23, wherein, the first end of the actuator is attached to the chassis at a point disposed below and to the rear of the operative connection between the motor and the driven wheel.

26. A wheelchair support apparatus, for a wheelchair having a seat and wheels, the apparatus comprising:
a unitized chassis and a lift mechanism, for operatively connecting a seat and wheels of a wheelchair;
the chassis comprising a substantially planar base plate and a peripheral side plate;
the base plate defining a periphery of the base plate, a longitudinal axis of the chassis, and a transverse axis of the chassis extending substantially perpendicular to the longitudinal axis;
the peripheral side plate having an edge thereof joined as a unitized structure to the periphery of the base plate, and having a width thereof extending substantially orthogonally to the base plate, whereby, when the chassis is oriented for operative attachment of the seat and wheels of the wheelchair, the base plate and peripheral side plate of the chassis form an open-bottomed box-shaped shell, with the base plate forming top surface of the chassis, and the peripheral side plate depending substantially downward from the base plate;
the lift mechanism having a lower end thereof operatively attached to the chassis, and an upper end thereof including seat attachment elements for attachment of the seat to the lift mechanism.

27. The support apparatus of claim 26, wherein the lift mechanism is a scissors lift mechanism.

28. The support apparatus of claim 27, wherein the scissors lift mechanism comprises:
an upper and a lower inner frame, each having left and right side links thereof joined into a unitized structure by a non-protruding crossmember, with each of the left and right side links of the upper and lower inner frames having a respective upper and lower attachment point at opposite ends thereof and a respective intermediate attachment point disposed between the upper and lower attachment points; and
an upper and a lower pair of outer links, with each outer link having upper and lower attachment points at opposite ends thereof and an intermediate attachment point disposed between the upper and lower attachment points of the outer links;
the pair of lower outer links including a right and a left lower outer link rotatably joined at the respective intermediate attachment points thereof to the right and left side links of the lower inner frame respectively, at the intermediate attachment points of the right and left side links of the lower inner frame;
the pair of upper outer links including a right and a left upper outer link rotatably joined at the respective intermediate attachment points thereof to the right and left side links of the upper inner frame respectively, at the intermediate points of the right and left side links of the upper inner frame;
the lower ends of the right and left upper outer links being rotatably joined respectively to the upper ends of the right and left side links of the lower inner frame; and
the upper ends of the right and left lower outer links being rotatably joined respectively to lower ends of the right and left side links of the upper inner frame.

29. The support apparatus of claim 28, wherein:
the scissors mechanism further comprises, a lower guide apparatus, including a translating element operatively joined to a guide element for translating movement of the translating element relative to the guide elemet; and
the lower ends of either the lower outer links or the left and right side links of the lower inner frame are rotatably connected to the translating element of the lower guide apparatus.

30. The support apparatus of claim 29, wherein the guide element of the lower guide apparatus includes a pair of guide rods, spaced from and extending parallel to one another.

31. The support apparatus of claim 29, wherein the lower ends of the outer links are rotatably attached to the chassis, the lower ends of the right and left side links of the lower inner frame are attached to the translating element of the lower guide apparatus, and the guide element of the lower guide apparatus is attached to the chassis, in a manner constraining the lower ends of the lower inner frame to translate along the longitudinal axis, as the scissors mechanism moves between a fully raised and a fully lowered position the scissors mechanism with respect to the chassis.

32. The support apparatus of claim 31, wherein the scissors lift mechanism further includes a linear actuator operatively attached between the chassis and the translating element for moving the translating element in a longitudinal direction along the guide element.

33. The support apparatus of claim 32, wherein the linear actuator has a first end thereof rotatably attached to the chassis and a second end thereof rotatably attached to the lower inner frame, with the actuator providing relative linear movement between the first and second ends of the linear actuator.

34. The support apparatus of claim 33, wherein the linear actuator includes a hydraulic cylinder for moving the first and second ends of the linear actuator relative to one another.

35. The support apparatus of claim 28, wherein:
the scissors lift mechanism further comprises, an upper guide apparatus, including a translating element operatively joined to a guide element for translating movement of the translating element relative to the guide element; and
the upper ends of either the upper outer links or the left and right side links of the upper inner frame are rotatably connected to the translating element of the upper guide apparatus.

36. The support apparatus of claim 35, wherein the guide element of the upper guide apparatus includes a pair of guide rods, spaced from and extending parallel to one another.

37. The support apparatus of claim 35, wherein:
the scissors mechanism further includes a seat mounting plate;
the upper ends of the right and left side links of the upper inner frame are attached to the seat mounting plate, the upper ends of the upper outer links are rotatably attached to the translating element of the upper guide apparatus, and the guide element of the upper guide apparatus is attached to the seat mounting plate, in a manner constraining the upper ends of the upper inner frame to translate along the longitudinal axis, as the scissors mechanism moves between a fully raised and a fully lowered position the seat mounting plate with respect to the chassis.

38. The support apparatus of claim 37, wherein the seat mounting plate is a unitized structure having a substantially planar mounting base defining a periphery of the mounting base, a longitudinal axis of the mounting plate, and a transverse axis of the mounting plate extending substantially perpendicular to the longitudinal axis of the seat mounting plate; and
a peripheral mounting plate side wall, having an edge thereof joined as a unitized structure to the periphery of the mounting base, and having a width thereof extending substantially orthogonally to the mounting base.

39. The support apparatus of claim 38, wherein, the peripheral mounting plate sidewall includes a flange extending therefrom.
